(19) United States
(12) Patent Application Publication
(10) Pub. No.: US 2008/0057589 A1
(43) Pub. Date: Mar. 6, 2008

(54) Method For Determining The Presence Of A Chemical Compound Which Is Homogeneously Distributed In A Medium By Means Of Cross-Correlating A Measuring Spectrum With Reference Spectra

(75) Inventors: Ruediger Sens, Ludwigshafen (DE); Christos Vamvakaris, Mannheim (DE); Sophia Ebert, Mannheim (DE); Erwin Thiel, Wilnsdorf (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/572,324

(22) PCT Filed: Jul. 19, 2005
(86) PCT No.: PCT/EP05/07839

§ 371 Date: Jan. 19, 2007

(30) Foreign Application Priority Data
Jul. 23, 2004 (DE) 10 2004 035 948.2

(51) Int. Cl. G01N 23/00

(52) U.S. Cl. 436/57

(57) ABSTRACT

The present invention relates to a method for determining the identity or non-identity of at least one chemical compound V′ homogeneous y distributed in a medium, by a) exposing the medium containing at least one homogeneously distributed chemical compound V′ to analysis radiation with a variable wavelength λ, and b) determining the spectral measurement function I′(λ) with the aid of the absorbed, reflected, emitted and/or scattered radiation,
wherein a correlation function K(δλ,c′,c) is determined according to Equation I

$$K ( δ λ , {c}^{′} , c ) = 1 / N \cdot {\int }_{- ∞}^{+ ∞} {I}^{′} ( λ , {c}^{′} ) \cdot I ( λ + δ λ , c ) ⅆ λ \qquad ( I )$$

in which K(δλ,c′,c) denotes the correlation depending on the relative shift δλ of the functions I′(λ,c′) and I(λ,c) and the concentrations c′ and c of the at least one chemical compound V′ and V, c′ denotes the concentration of the at least one chemical compound V′ homogeneously distributed in the medium, with a known or suspected identity, c denotes the concentration of the at least one chemical compound V homogeneously distributed in the medium, with a known identity, I′(λ,c′) denotes the measurement function of the at least one homogeneously distributed chemical compound V′ in a medium containing the concentration c′, I(λ,c) denotes the comparison function of the at least one homogeneously distributed chemical compound V in a medium containing the concentration c, and N denotes a normalization factor and identity or non-identity between the compounds V and V′ is determined with the aid of the correlation function K(δλ,c′,c).

The present invention relates to a method for determining the identity or non-identity of at least one chemical compound V′ homogeneously distributed in a medium by
a) exposing the medium containing at least one homogeneously distributed chemical compound V′ to analysis radiation with a variable wavelength λ, and
b) determining the spectral measurement function I′(λ) with the aid of the absorbed, reflected, emitted and/or scattered radiation,
wherein a correlation function K(δλ,c′,c) is determined according to Equation I

$$K ( δ λ , {c}^{′} , c ) = 1 / N \cdot {\int }_{- ∞}^{+ ∞} {I}^{′} ( λ , {c}^{′} ) \cdot I ( λ + δ λ , c ) ⅆ λ \qquad ( I )$$

in which
K(δλ,c′,c) denotes the correlation depending on the relative shift δλ of the functions I′(λ, c′) and I(λ,c) and the concentrations c′ and c of the at least one chemical compound V′ and V,
c′ denotes the concentration of the at least one chemical compound V′ homogeneously distributed in the medium, with a known or suspected identity,
c denotes the concentration of the at least one chemical compound V homogeneously distributed in the medium, with a known identity,
I(λ,c′) denotes the measurement function of the at least one homogeneously distributed chemical compound V′ in a medium containing the concentration c′,
I(λ,c) denotes the comparison function of the at least one homogeneously distributed chemical compound V in a medium containing the concentration c,
   and
N denotes a normalization factor
   and identity or non-identity between the compounds V and V′ is determined with the aid of the correlation function K(δλ,c′,c).

A large number of methods are employed for the identification and study of chemical compounds. Many of the analysis methods use a wide variety of analysis radiation types for this, which interact with the chemical compound to be studied and experience a change in their original intensity as a function of the wavelength in question by absorption, emission, reflection and/or scattering in this way, a measurement function I′(λ) is obtained which reproduces the modified intensity of the analysis radiation as a function of the wavelength in question.

If the chemical compound is homogeneously distributed in a medium, then a measurement function I′(λ,c′) is obtained which involves a dependency on the concentration c′ of the chemical compound in the medium. With only a low concentration of the chemical compound in the medium in question—for example, the chemical compound may be present as a component in a gas mixture, dissolved in a solvent or a solid substance, for instance a polymer—then the contribution of the chemical compound to the measurement function I′(λ,c′) is so small that it cannot be detected.

It is therefore an object of the present invention to provide a method which, on the one hand, makes it readily possible to determine extremely small concentrations of at least one chemical compound in a medium, which are too small to be detected by conventional methods based on analysis radiation, and, on the other hand, allows the identity or non-identity of at least one suspected chemical compound in a medium to be determined by comparison with a known chemical compound in the same medium, or in a medium which is as similar as possible.

The method as described in the introduction is therefore provided.

The term medium should be understood here as any substance which in principle allows homogeneous distribution of the chemical compound V′ or V. These are, for example, gases, paste-like substances, for example creams, liquids, for example pure liquids, liquid mixtures, dispersions and dyes as well as solids, for example plastics, with surface coatings on all kinds of substrates also being included as solids in the broad sense, for example consumer articles from everyday life, automobiles, and building facades etc., for example with cured coating applications.

Any radiation which can interact with the chemical compound(s) V′ or V and delivers a corresponding wavelength-dependent measurement function may be suitable as analysis radiation. Electromagnetic radiation is a particular example, although particle radiation such as neutron or electron radiation, or acoustic radiation such as ultrasound, may also be suitable. In principle, therefore, any known measurement method which makes it possible to determine a measurement function I′(λ,c′) or comparison function I(λ,c) is also suitable. Examples of widely used spectroscopic measurement methods for determining the measurement function are IR, NIR, Raman, UV, VIS or NMR spectroscopy.

The determination of the measurement function is conditional on the behavior of the system formed by the chemical compound V′ or V and the medium containing it. With sufficient transparency for the analysis radiation, the measurement function can reproduce the absorption and transmission behavior of the system. If this transparency is not available, or available only to an insufficient extent, the measurement function may reflect the reproduction of the wavelength-dependent reflection behavior of the system. If the system is stimulated by the analysis radiation so that it emits radiation, the wavelength-dependent emission behavior may be used as a measurement function. A combination of different measurement functions is also possible. For example, both the absorption (transmission) and emission behaviors of the system may be used as a basis for the determination method according to the invention.

The homogeneous distribution of the chemical compound V′ or V in the medium ensures that the measurement function obtained is not dependent on the measurement site.

In the case of gaseous media, the compounds V′ or V are generally gases or vapors. If a homogeneous distribution is achieved by suitable measures, then these compounds may also be present as finely divided solid particles.

In the case of paste-like or liquid media, the chemical compounds V or V are usually molecularly dissolved or likewise present as finely divided solid particles, although segregation of the solid particles is not generally a problem in paste-like media owing to the higher viscosity compared with gaseous or liquid media.

In the case of liquid media, homogeneous distribution of the solid particles when determining the measurement function or comparison function can be achieved by suitable measures, for example the presence of dispersants and/or continuous mixing. If such liquid media are dispersions or dyes, for example, then in general they will already be adjusted so that demixing does not take place, or takes place only over a prolonged period of time. The measurement function or comparison function can then normally be determined without problems. If appropriate, however, falsification of the measurement due to segregation may also be counteracted here by suitable homogenization methods.

In the case of solid media, and in particular plastics, the chemical compounds V′ or V are usually present as finely divided solid particles or molecularly dissolved. Naturally, therefore, demixing phenomena do not usually constitute a problem here. The method according to the invention may, on the one hand, be used for more accurate determination of the concentration of ingredients (corresponding to the at least one chemical compound V′) in a wide variety of media. Inter alia, it may be used for the determination of pollutants, for example nitrogen oxides, sulfur dioxide or finely divided airborne components in the atmosphere.

On the other hand, the method according to the invention may also be employed in order to determine the authenticity or non-authenticity of a medium, which contains at least one chemical compound V′ as a tagging substance. It is particularly advantageous in this case that the tagging substance can be added in amounts so small that it cannot be detected either visually or by conventional spectroscopic analysis methods. The method according to the invention can therefore be used to determine the authenticity of appropriately tagged product packaging, for mineral oils etc., or even to discover the existence of (possibly illegal) manipulations.

The measurement function I′(λ,c′) or comparison function I(λ,c) is usually approximated by a variable number of sample values, with a large number of sample values expediently being used for a complex profile of the measurement and comparison functions, while making do with fewer sample values for measurement and comparison functions with a simpler profile. Accordingly, it is necessary to measure the intensities I′ and I at a multiplicity, or even only a comparatively small number of different wavelengths λ in order to obtain meaningful results.

Accordingly, Equation I

$$K ( δ λ , {c}^{′} , c ) = 1 / N \cdot {\int }_{- ∞}^{+ ∞} {I}^{′} ( λ , {c}^{′} ) \cdot I ( λ + δ λ , c ) ⅆ λ \qquad ( I )$$

may also be approximated by Equation II

$$K ( δ λ , {c}^{′} , c ) = 1 / {N}^{*} \cdot {\sum }_{i = 1}^{n} {I}_{i}^{′} ( {λ}_{i} , {c}^{′} ) \cdot {I}_{i} ( {λ}_{i} + δ λ , c ) \qquad ( II )$$

in which n denotes the number of sample values, I′ᵢ and Iᵢ denote the respective intensities at the wavelength λᵢ, and N* is again a normalization factor.

In particular cases, it is also possible to determine the comparison function and measurement function respectively in different media. This is possible, in particular, when the effect of the medium in the relevant wavelength range is small and the comparison function or measurement function is accordingly determined merely, or predominantly, by the measurement response of the chemical compound V or V′.

The normalization factor N makes it possible to scale the correlation function K(δλ,c′,c) to an intended wavelength range. N will usually be selected so that K(δλ,c′,c) takes values of between 0 and 1, a value of 0 corresponding to no correlation and a value of 1 corresponding to maximum consolation between the measurement function I′(λ,c′) and the comparison function I(λ,c). Accordingly, the normalization factor N (for δλ=0, that is to say maximum correlation) is

$$N = {\int }_{- ∞}^{+ ∞} {I}^{′} ( λ , {c}^{′} ) \cdot I ( λ + δ λ , c ) ⅆ λ$$

and the normalization factor N*(for δλ=0, that is to say maximum correlation) is

$${N}^{*} = {\sum }_{i = 1}^{n} {I}_{i}^{′} ( {λ}_{i} , {c}^{′} ) \cdot {I}_{i} ( {λ}_{i} , c )$$

The spectral shift δλ usually comprises a wavelength range in which the measurement function I′(λ,c′) or comparison function I(λ,c) is reproduced fully, or almost fully. It is usually a range B of 0≦δλ≦10·FWHM (Full Width half Maximum), where FWHM corresponds to the width of the measurement function I′(λ,c′) or comparison function I(λ,c) at half maximum intensity I′ₘₐₓ or Iₘₐₓ.

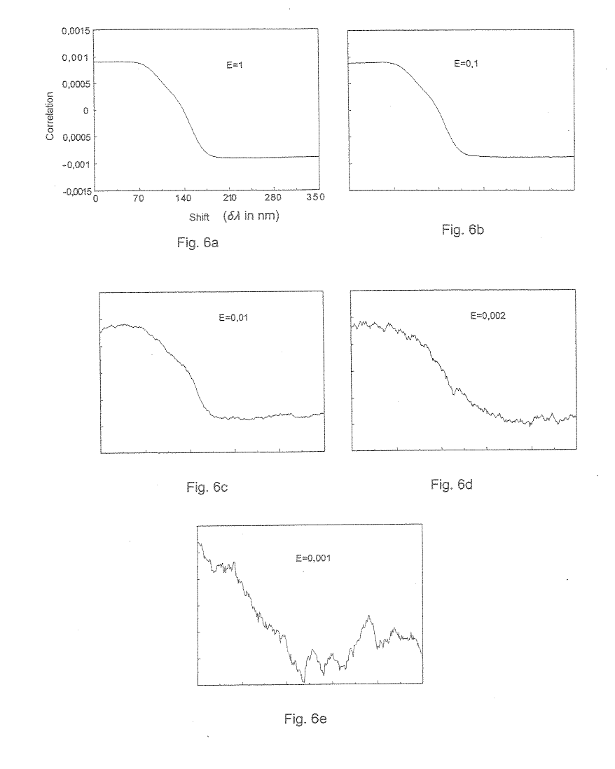

The curve of K(δλ,c′,c) as a function of δλ calculated according to Equation (I) or (II) for given values of c′ or c typically appears as represented in FIGS. 6a to 6e. If I′ᵢ(λᵢ,c′) is replaced by the function I(λ,c) in Equation (I), or I′ᵢ(λᵢ,c′) is replaced by the function Iᵢ(λᵢ,c) in Equation (II), then a noise-free correlation function (autocorrelation function) is obtained which is the same as the representation in FIG. 6a.

As the concentration c′ decreases, the background noise increases both for the measurement function and for the correlation function K(δλ,c′,c). With the aid of conventional statistical methods, however, it is readily possible to establish the probability with which the noise-free correlation function can be detected in a multiplicity of measurements of noisy correlation functions K(δλ,c′,c). A statistical evaluation of 50 individual measurements, for example, each of which is per se similar to the graphical representation of the correlation function in FIG. 6e, gives a correlation factor—and therefore identity detection—of ≧95%.

Once the identity of the chemical compound V or V′ has been confirmed, then Equation (I) can be used in order to determine the concentration c′. The normalization factor N or N* is equal to 1 for this case. The concentration c′ can be calculated numerically from the value of K(δλ,c′,c).

The method according to the invention is preferably used in order to determine the identity or non-identity of at least one chemical compound V′ homogeneously distributed in a liquid or solid medium.

The chemical compound V′ or V may in principle be any substance distributed or distributable homogeneously in the medium, which interacts with the analysis radiation being employed. The substance may necessarily be contained in the medium according to its provenance or may have been added deliberately to the medium, for example for tagging purposes.

For example, such substances may be byproducts due to the production of the medium or traces of catalysts which had been used during the production of the media (for example solvents, dispersions, plastics etc.). In the case of natural products, for instance plant oils, these substances may be typical of the cultivation site of the plants containing the oil. The origin of the oil can therefore be confirmed or denied by determining the identity or non-identity of the substances. The same applies, for example, to petroleum types which have a spectrum of typical minor constituents depending on the oil field.

If at least one chemical compound V′ has been deliberately added to the medium, for example a liquid, then it is possible to determine that the medium tagged in this way is authentic, or discover possible manipulations. In this way, for example, fuel oil which usually has tax concessions can be distinguished from diesel oil, which in general is taxed more heavily, or liquid product flows in industrial systems, for example natural oil refineries, can be tagged and thereby tracked. Since the method according to the invention makes it possible to determine very small concentrations of the at least one chemical compound V′, this can be added to the medium in a correspondingly small concentration; any possible negative effect due to the presence of the compound, for example during the combustion of heating or diesel oil, can therefore be prevented.

Similarly, for example, spirits can be marked so that properly manufactured taxed and sold alcoholic drinks can be distinguished from illegally manufactured and sold goods. What is important here, naturally is that chemical compounds V which are safe for human consumption should be used for the tagging.

It is furthermore possible to use at least one chemical compound V′ to tag plastics or paints. This may again be done in order to determine the authenticity or non-authenticity of the plastics or paints, or in order to ensure type-specific classification of used plastics with a view to their recycling. The increased sensitivity of the method according to the invention is advantageous in this case as well, since the at least one chemical compound V′, for example a dye, may be added in only very small amounts and therefore not affect the physical appearance of the plastics or paints, for example.

Particularly preferably, the method according to the invention may also be used in order to determine the identity or non-identity of at least one chemical compound V′ homogeneously distributed in a liquid medium.

Liquid media which may be mentioned are in particular organic liquids and their mixtures, for example alcohols such as methanol, ethanol, propranol, isopropanol, butanol, isobutanol, sec-butanol, pentanol, isopentanol, neopentanol or hexanol, glycols such as 1,2-ethylene glycol, 1,2- or 1,3-propylene glycol, 1,2-, 2,3- or 1,4-butylene glycol, di- or triethylene glycol or di- or tripropylene glycol, ethers such as methyl tert-butyl ether, 1,2-ethylene glycol mono- or dimethyl ether, 1,2-ethylene glycol mono- or diethyl ether, 3-methoxypropanol, 3-isopropoxypropanol, tetrahydrofuran or dioxane, ketones such as acetone, methyl ethyl ketone or diacetone alcohol, esters such as methyl acetate, ethyl acetate, propyl acetate or butyl acetate, aliphatic or aromatic hydrocarbons such as pentane, hexane, heptane, octane, isooctane, petroleum ether, toluene, xylene, ethylbenzene, tetralin, decalin, dimethyinaphthalene, white spirit, mineral oil such as gasoline, kerosene, diesel oil or heating oil, natural oils such as olive oil, soybean oil or sunflower oil, or natural or synthetic motor, hydraulic or gear oils, for example vehicle motor oil or sewing machine oil, or brake fluids. These are also intended to include products which are produced by processing particular types of plant, for example rape or sunflower. Such products are also referred to by the term “bio-diesel”.

According to the invention, the method may also be used in order to determine the identity or non-identity of at least one chemical compound V′ homogeneously distributed in mineral oil. In this case, the at least one chemical compound is particularly preferably a tagging substance for mineral oils.

Tagging substances for mineral oils may be most substances which have absorption in the visible and invisible wavelength range of the spectrum (for example in the NIR). A very wide variety of compound classes have been proposed as tagging substances, for example phthalocyanines, naphthalocyanines, nickel-dithiolene complexes, aminium compounds of aromatic amines, methine dyes and azulene-squaric acid dyes (for example WO 94/02570 A1, WO 96/10620 A1, prior German patent application 10 2004 003 791.4) as well as azo dyes (for example DE 21 29 590 A1, U.S. Pat. No. 5,252,106, EP 256 460 A1, EP 0 509 818 A1, EP 0 519 270 A2, EP 0 679 710 A1, EP 0 803 563 A1, EP 0 989 164 A1, WO 95/10581 A1, WO 95/17483 A1). Anthraquinone derivatives for the coloring/tagging of gasoline or mineral oils are described in the documents U.S. Pat. No. 2,611,772, U.S. Pat. No. 2,068,372, EP 1 001 003 A1, EP 1 323 811 A2 and WO 94/21752 A1 and the prior German patent application 103 61 504.0.

Substances which do not lead to a visually or spectroscopically detectable color reaction until after extraction from the mineral oil and subsequent derivatization have also been described as tagging substances for mineral oil. Such tagging substances are, for instance, aniline derivatives (for example WO 94/11466 A1) or naphthylamine derivatives (for example U.S. Pat. No. 4,209,302, WO 95/07460 A1). Using the method according to the invention, it is possible to detect aniline and naphthylamine derivatives without prior derivatization.

Extraction and/or further derivatization of the tagging substance, as mentioned in some of the cited documents, in order to obtain an increased color reaction or to concentrate the tagging substance so that its color can be better determined visually or spectroscopically, is also possible but generally unnecessary according to the present method.

Document WO 02/50216 A2 discloses inter alia aromatic carbonyl compounds as tagging substances, which are detected UV-spectroscopically. With the aid of the method according to the invention, it is possible to detect these compounds at much lower concentrations.

The tagging substances as described in the cited documents may of course also be used to tag other liquids, such liquids having already been mentioned by way of example.

### EXAMPLES

Correlation-spectroscopically different anthraquinone dyes were studied as tagging substances for mineral oil.

A) Preparation of the Anthraquinone Dyes

### Example 1

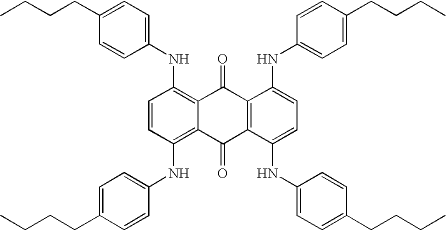 (CAS No.: 108313-21-9, molar mass 797.11; C₅₄H₆ N₄O₂ λₘₐₓ=760 nm (toluene))

1,4,5,8-Tetrakis[(4-butylphenyl)amino]-9,10-anthracendione was synthesized similarly as in Document EP 204 304 A2.

For this purpose, 82.62 g (0.5370 mole) of 4-butylaniline (97%) were provided, 11.42 g (0.0314 mole) of 1,4,5,8-tetrachloroanthraquinone (95.2%), 13.40 g (0.1365 mole) of potassium acetate, 1.24 g (0.0078 mole) of anhydrous copper(II) sulfate and 3.41 g (0.0315 mole) of benzyl alcohol were added and the batch was heated to 130° C. It was stirred for 6.5 h at 130° C., then heated to 170° and stirred again for 6 h at 170° C. After cooling the 60° C., 240 ml of acetone were added, suction was applied at 25° C. and the residue was washed first with 180 ml of acetone and then with 850 ml of water until the filtrate had a conductance of 17 μS. The washed residue was finally dried. 19.62 g of product were obtained, corresponding to a yield of 78.4%.

In entirely the same way, the compounds listed below were synthesized by reacting 1,4,5,8-tetrachloroanthraquinone with the appropriate aromatic amines:

### Example 2

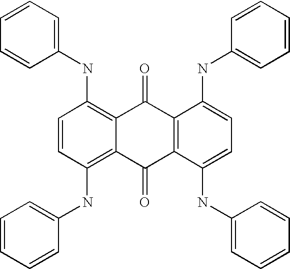

### Example 3

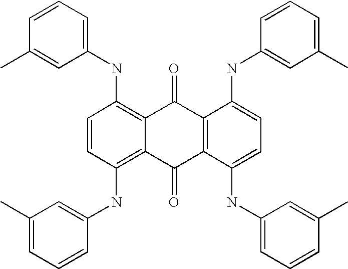

### Example 4

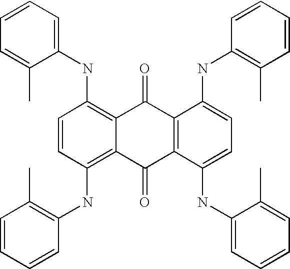

### Example 5

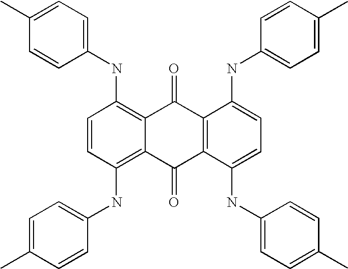

### Example 6

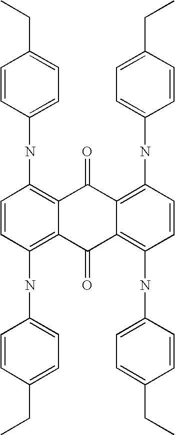

### Example 7

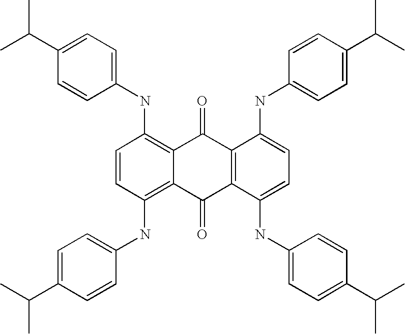

### Example 8

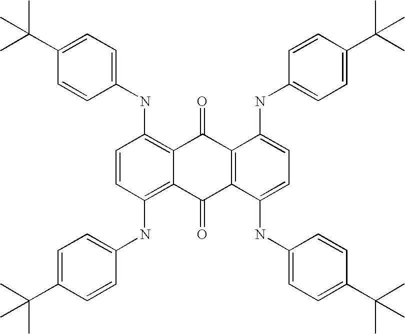

### Example 9

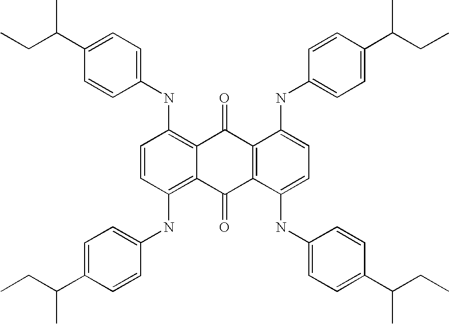

### Example 10

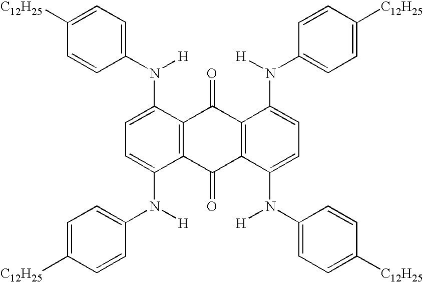

### Example 11

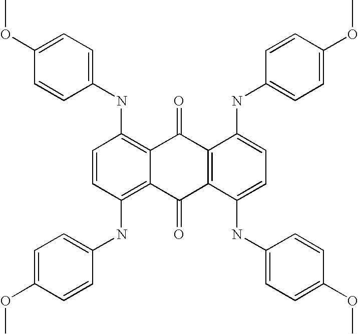 B1) Correlation Analysis of the Anthraquinone Dyes in Absorption

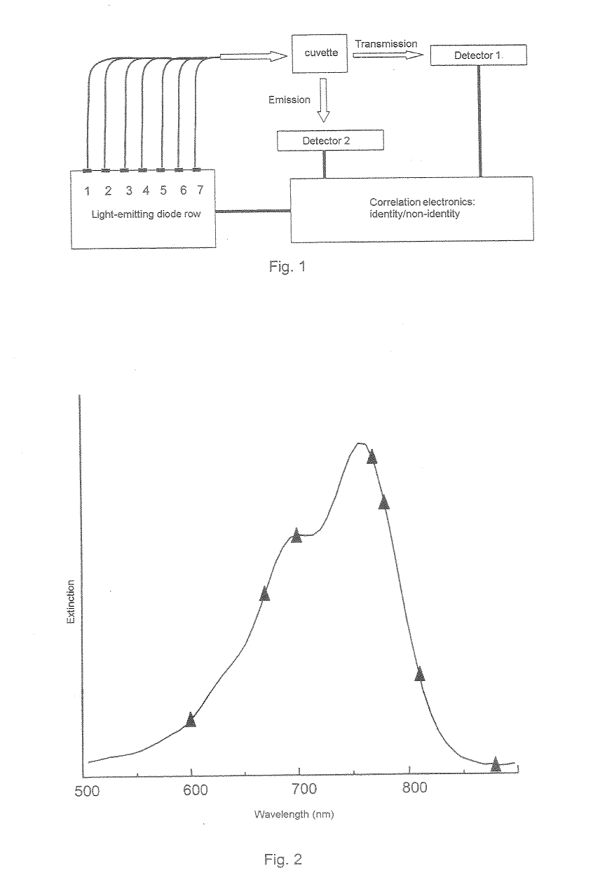

FIG. 1 describes by way of example the schematic experimental setup based on seven wavelength sample values corresponding to seven light-emitting diodes (“1” to “7” in the “light-emitting diode row” block). With the aid of the intensity-stabilized light-emitting diode row, the radiation of the individual light-emitting diodes was selectively injected via optical fibers into a 1 cm cuvette. The transmitted or emitted light fluorescence or phosphorescence) is detected in detectors 1 and 2 (silicon diodes). The detection signals are evaluated with the aid of correlation electronics and, as described above, checked for identity or non-identity. The light-emitting diodes of the light-emitting diode row had the following emission wavelengths in nm:

Light-emitting diode 1: 600

Light-emitting diode 2: 670

Light-emitting diode 3: 700

Light-emitting diode 4: 770

Light-emitting diode 5: 780

Light-emitting diode 6: 810

Light-emitting diode 7: 880

The power of the light-emitting diodes lay in the range of from 1 to 10 mW.

The spectral position of the radiation emitted by the individual light-emitting diodes, relative to the absorption spectrum of the anthraquinone dye according to Example 1, is schematically shown in FIG. 2 with the aid of the marked triangles, the ordinate values not being specified further.

The anthraquinone dye according to Example 1 was dissolved with the following concentrations in toluene:

Weigh-in
(ppb by weight)

8877.0
3548.2
1563.7
846.4
470.2
337.9
272.6
154.6
89.3
44.6

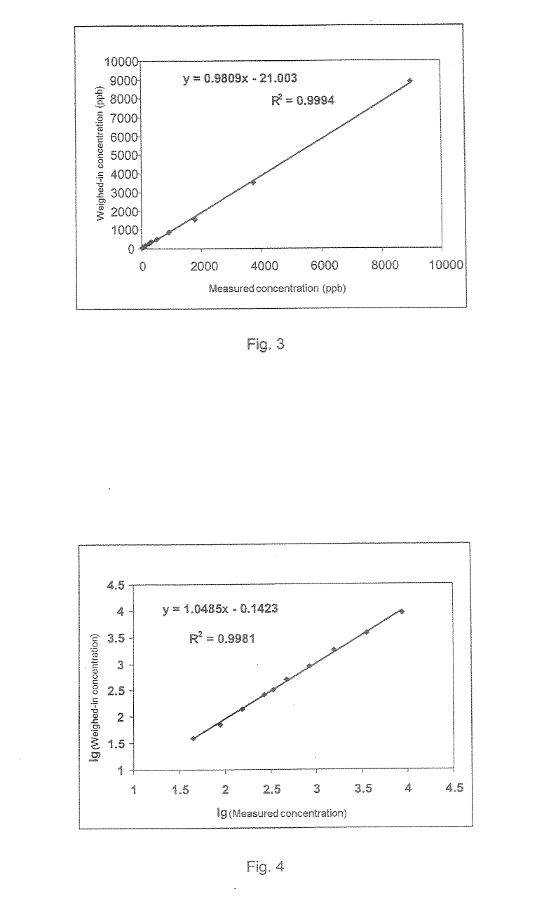

If the weighed-in concentrations are respectively plotted linearly against the correlation-analytically determined concentrations (ppb by weight), then the straight line with a high correlation factor is obtained as shown in FIG. 3.

The logarithmic-logarithmic plot in FIG. 4 shows that the correlation continues into the lower ppb range (by weight).

Similar results were obtained with the same measurement setup for the anthraquinone dyes of Examples 2 to 11 (with comparable concentrations in toluene), for which reason it is unnecessary to give a corresponding presentation of the measurement results.

Once the identity of a compound has been ascertained, the method according to the invention makes possible to determine much smaller concentrations of this compound than a conventional spectroscopic measurement.

B2) Correlation Analysis of a Cationic Cyanine Dye in Absorption

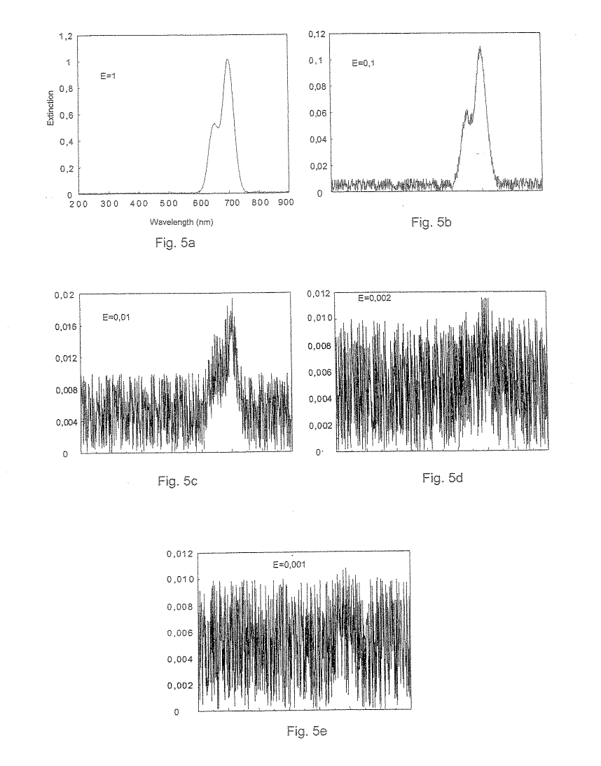

FIGS. 5a to 5e show the absorption spectra obtained with a dilution series of a cationic cyanine dye. The abscissa value range in FIGS. 5b to 5e corresponds to that in FIG. 5a. The abscissa legend is therefore omitted from the former. The relative concentrations were 1.0 (FIG. 5a; relative extinction at the absorption maximum: E=1), 0.1 (FIG. 5b; relative extinction at the absorption maximum: E=0.1), 0.01 (FIG. 5c; relative extinction at the absorption maximum: E=0.01), 0.002 (FIG. 5d; relative extinction at the absorption maximum: E=0.002) and 0.001 (FIG. 5e; relative extinction at the absorption maximum: E=0.001). Although the absorption by the dye can still be detected in the spectra of FIGS. 5a to 5c, FIGS. 5d and 5e reach or fall below the detection limit.

FIGS. 6a to 6e show the correlation functions corresponding to the spectra in FIGS. 5a to 5e. Since the ordinate and abscissa value ranges in FIGS. 6b to 6e correspond to those in FIG. 5a, the axis legends are omitted from the former. The correlation values K(δλ,c′,c) lie in the range of from about −0.001 to about 0.001, but can be converted into any other value range, for example from 0 to 1, by shifting parallel to the ordinate and changing the scale.

The step profile typical of the correlation function can be seen clearly in FIGS. 6a to 6d. As mentioned above, the correlation shown in FIG. 6e offers a positive result concerning the identity of the compound being studied.

It should also be mentioned here that all the correlation functions shown in FIGS. 6a to 6e are based on just one measurement. If the measurements are in fact carried out repeatedly with lower concentrations of the dye, and the measurement values obtained are added up, then the signal/noise ratio can be improved so that the information in the correlation graphs is also correspondingly improved.

1. A method for determining the identity or non-identity of at least one chemical compound V′ homogeneously distributed in a medium, by
a) exposing the medium containing at least one homogeneously distributed chemical compound V′ to analysis radiation with a variable wavelength λ, and
b) determining the spectral measurement function I′(λ) with the aid of the absorbed, reflected, emitted and/or scattered radiation,
wherein a correlation function K(δλ,c′,c) is determined according to Equation I
$$K ( δ λ , {c}^{′} , c ) = 1 / N \cdot {\int }_{- ∞}^{+ ∞} {I}^{′} ( λ , {c}^{′} ) \cdot I ( λ + δ λ , c ) ⅆ λ \qquad ( I )$$
in which
K(δλ,c′,c) denotes the correlation depending on the relative shift δλ of the functions I′(λ,c′) and I(λ,c) and the concentrations c′ and c of the at least one chemical compound V′ and V,
c′ denotes the concentration of the at least one chemical compound V′ homogeneously distributed in the medium, with a known or suspected identity,
c denotes the concentration of the at least one chemical compound V homogeneously distributed in the medium, with a known identity,
I′(λ,c′) denotes the measurement function of the at least one homogeneously distributed chemical compound V′ in a medium containing the concentration c′,
I(λ,c) denotes the comparison function of the at least one homogeneously distributed chemical compound V in a medium containing the concentration c,
and
N denotes a normalization factor
and identity or non-identity between the compounds V′ and V is determined with the aid of the correlation function K(δλ,c′,c).

2. The method as claimed in claim 1, which is used in order to determine the identity or non-identity of at least one chemical compound V′ homogeneously distributed in a liquid or solid medium.

3. The method as claimed in claim 1, which is used in order to determine the identity or non-identity of at least one chemical compound V′ homogeneously distributed in a liquid medium.

4. The method as claimed in claim 3, wherein the liquid medium is a mineral oil.

5. The method as claimed in claim 4, wherein the at least one compound V and the at least one compound V′ are tagging substances for mineral oils.
